(19) United States
(12) Patent Application Publication
(10) Pub. No.: US 2019/0130270 A1
(43) Pub. Date: May 2, 2019

(54) TENSOR MANIPULATION WITHIN A RECONFIGURABLE FABRIC USING POINTERS

(71) Applicant: Wave Computing, Inc., Campbell, CA (US)

(72) Inventors: Christopher John Nicol, Campbell, CA (US); David Jay O'Shea, Costa Mesa, CA (US)

(21) Appl. No.: 16/208,991

(22) Filed: Dec. 4, 2018

Related U.S. Application Data
(63) Continuation-in-part of application No. 16/170,268, filed on Oct. 25, 2018.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.
(60) Provisional application No. 62/773,486, filed on Nov. 30, 2018.

(51) Int. Cl. G06N 3/08; G06N 3/04

(52) U.S. Cl. CPC G06N 3/08; G06N 3/0445

(57) ABSTRACT

Techniques are disclosed for tensor manipulation within a reconfigurable fabric using pointers. A first tensor is obtained for processing on a reconfigurable fabric comprised of a plurality of processing, storage, and switching elements. A first agent is deployed on one or more of the plurality of processing elements of the reconfigurable fabric. The first tensor is manipulated by the first agent. The results of the manipulating the first tensor are stored in a storage element external from the first agent. A pointer is provided to a second agent deployed on one or more of the plurality of processing elements of the reconfigurable fabric, wherein the pointer identifies an address of the storage element at which the first tensor is stored. A transfer buffer is used between the first agent and the second agent within the reconfigurable fabric to facilitate tensor transfers between the first agent and the second agent.

### RELATED APPLICATIONS

This application claims the benefit of U.S. provisional patent applications “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, and “Reconfigurable Fabric Configuration Using Spatial and Temporal Routing” Ser. No. 62/773,486, filed Nov. 30, 2018.

This application is also a continuation-in-part of U.S. patent application “Tensor Manipulation Within a Neural Network” Ser. No. 16/170,268, filed Oct. 25, 2018, which claims the benefit of U.S. provisional patent applications “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to tensor manipulation and more particularly to tensor manipulation within a reconfigurable fabric using pointers.

### BACKGROUND

Governments, businesses, and researchers routinely collect data for such purposes as surveillance, tracking, and learning. A result of these massive data collection efforts is datasets that continuously and quickly balloon. The collected datasets, which are often referred to as “big data”, present significant data processing challenges due to the sheer volume of data to be processed. While the data processing challenges are massive, the various entities that collect the data are compelled to perform the analysis for security, commercial, regulation, and research purposes. The entities are highly motivated to perform a variety of tasks which are based on the data. The tasks typically include learning, marketing, and predicting, among many others. Other impediments to “big data” processing include the processors, integrated circuits, and other computing hardware used to perform the data processing techniques. Traditional architectures, processors, and algorithms cannot process and analyze the “big data” datasets because the analysis overwhelms the computational capabilities of the conventional systems and approaches. In addition, with regard to data access, the analysis, capture, maintenance, storage, transmission, visualization, and so on, quickly overwhelm the processing and rendering capabilities of the traditional systems. There would be little or no value to the data if it could not be processed in a timely fashion. Instead, new and innovative processing hardware that can include advanced computer chips and architectures, and software such as algorithms, heuristics, techniques, and so on, is required.

The organizations, institutions, laboratories, schools, and others that possess the datasets or have access to the datasets are motivated to perform a variety of analysis tasks on the data which is contained in the datasets. Analysis purposes that are commonly addressed include business analysis; complex science and engineering simulations; crime detection and prevention; and meteorology; to name only a few. Advanced data analysis techniques such as predictive analytics are promising because these techniques can be used for extracting value from the datasets for business and other purposes. Other uses for the datasets include machine learning and deep learning.

One or more metrics can be used to measure data processing performance of hardware and software. The metrics can include high throughput including data throughput, fast response time for data processing, low computational resources utilization, and so on. Performance can also be based on other criteria such as high data bandwidth, high hardware availability, efficient data storage and transfer, among others. System, hardware, and software design techniques have been developed to address these and other design issues, and are used while a data processing technique is being developed. “Performance engineering” is one approach that has been developed for effective and efficient system design. Performance engineering seeks to examine design tradeoffs. The design tradeoffs include determining which performance requirements can be met by various proposed architectures and at what cost, which functions should be implemented in hardware, and which functions should be implemented in software. The principal objective of performance engineering is to meet the design performance requirements while also maintaining or minimally impacting other system performance measures. When done properly, the result of the design process is a high-performance design that is obtained while minimizing both cost and the use of computational resources.

### SUMMARY

Reconfigurable computing has its foundations on a combination of hardware and software techniques. A reconfigurable computing architecture can be “recoded” to perform a variety of tasks, similar to software, while the underlying architecture of the hardware is capable of high performance. A reconfigurable fabric is one such architecture used for reconfigurable computing. Reconfigurable fabrics can be arranged in a variety of topologies, where the topologies are coded for many applications that require high performance computing. Applications such as data processing, digital signal processing (DSP), neural networks such as convolutional neural networks (CNN) and deep neural networks (DNN), and so on, are well served by the capabilities of a reconfigurable fabric. The capabilities of the reconfigurable fabric fare particularly well when the data can include specific types of data, large quantities of unstructured data, and the like. The reconfigurable fabrics can be coded or scheduled to realize these and other processing techniques. Further, the reconfigurable fabric can be scheduled to represent a variety of computer architectures that can perform computations more efficiently. By adopting other coding concepts such as the use of pointers, and applying these concepts to the scheduling of the reconfigurable fabric, even higher performance can be attained by the reconfigurable fabric.

Tensor manipulation is realized within a reconfigurable fabric using pointers. The reconfigurable fabric includes a variety of “elements” such as processing elements, switching elements, storage elements, communications capabilities, and so on. Embodiments include a processor-implemented method for tensor manipulation comprising: obtaining a first tensor for processing on a reconfigurable fabric comprised of a plurality of processing elements, storage elements, and switching elements; deploying a first agent on one or more of the plurality of processing elements of the reconfigurable fabric; manipulating the first tensor by the first agent; storing the results of the manipulating the first tensor in a storage element external from the first agent; providing a pointer to a second agent deployed on one or more of the plurality of processing elements of the reconfigurable fabric, wherein the pointer identifies an address of the storage element at which the first tensor is stored; and processing the first tensor by the second agent. In some embodiments, a “pointer done” signal is issued by the second agent to the first agent after the second agent has completed manipulating the first tensor. In embodiments, the method further comprises releasing, by the first agent, the results of the manipulating the first tensor, from the storage element, after the second agent issues the pointer done signal.

Some embodiments comprise using a transfer buffer between the first agent and the second agent within the reconfigurable fabric to facilitate tensor transfers between the first agent and the second agent. In embodiments, the transfer buffer facilitates the tensor transfers by storing the pointer that was provided. And in embodiments, the transfer buffer comprises a FIFO. And in other embodiments, the transfer buffer is controlled by a rotating circular buffer.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for tensor manipulation within a reconfigurable fabric using tensors.

FIG. 2 is a flow diagram for inter-agent pointer storage.

FIG. 3 is a flow diagram for signal issuing.

FIG. 4 illustrates tensor passing by pointers.

FIG. 5 is a flow diagram for storage allocation.

FIG. 6 is an example illustrating forking of pointers to an agent.

FIG. 7 shows a cluster for coarse-grained reconfigurable processing.

FIG. 8 illustrates a block diagram of a circular buffer.

FIG. 9 illustrates a circular buffer and processing elements.

FIG. 10 is a system diagram for pipelined tensor manipulation within a reconfigurable fabric.

### DETAILED DESCRIPTION

Techniques are disclosed for tensor manipulation within a reconfigurable fabric using pointers. A pointer can be an object in a programming language. A pointer can contain a value, where the pointer value references or “points to” another value. The other value can be stored in an element capable of storing values, such as a storage element within the reconfigurable fabric, a storage element coupled to the reconfigurable fabric, a register, a buffer, a memory, and so on. Pointers frequently have been used when writing code, where the pointers can be used to reference data, objects, etc. The advantage of using the pointer is that when passing the pointer from one process to another process, or from one processor to another processor, the value of the pointer can be represented using less storage than can the values to which the pointer refers. Further, the pointer can be shared among processes and processors. The shared pointer allows the processes and processors to access a single copy of the referenced values, rather than having to make copies of the referenced data for each process and each processor that accesses the referenced data. Where a library can be considered analogous to a memory, a pointer can be thought of as a Library of Congress or Dewey Decimal reference number. By using the reference number, one may access the book, magazine, or other media object.

A reconfigurable fabric can include one or more types of elements. Depending on the type of element, the element can be configured to perform a variety of architectural and computational tasks. The elements can be configured as processing elements, storage elements, switching elements, and so on. The reconfigurable fabric can include clusters or quads of elements, where the quads can include processing elements, shared storage elements, switching elements, controls, communications paths, and the like. An element within the reconfigurable fabric can be controlled by providing code, where the code configures the element as a processing element, switching element, storage element, etc. Code can also be provided to a plurality of elements within the reconfigurable fabric so that the reconfigurable fabric can perform various computational tasks such as tensor manipulation. To control elements of the reconfigurable fabric, one or more rotating circular buffers can be used. Instructions or codes can be loaded into the circular buffer. Providing the instructions or codes to the rotating circular buffer can be thought of as scheduling the controlled elements for a specific set of tasks. The rotation of the circular buffer ensures that the same series of steps or instructions is repeated for as long and as frequently as required by the processing tasks assigned to an element of the reconfigurable fabric. The one or more rotating circular buffers can be statically scheduled.

Tensor manipulation is performed within a reconfigurable fabric using pointers. A first tensor is obtained for processing on a reconfigurable fabric comprised of a plurality of processing elements, storage elements, and switching elements. The tensor can include a plurality of arrays, a multidimensional matrix, etc. A first agent is deployed on one or more of the plurality of processing elements of the reconfigurable fabric. The processing elements can be controlled by a rotating circular buffer, where the circular buffer can be statically scheduled. The first tensor is manipulated by the first agent. The tensor manipulation can include a tensor operation such as tensor product, tensor contraction, raising a tensor index, lowering a tensor index, and so on. The results of the manipulating the first tensor are stored in a storage element external from the first agent. The storage element can be a storage element within the reconfigurable fabric, a storage element coupled to the reconfigurable fabric, etc. The storing the results of the manipulation of the first tensor can include a direct memory access (DMA) operation. A pointer is provided to a second agent deployed on one or more of the plurality of processing elements of the reconfigurable fabric, wherein the pointer identifies an address of the storage element at which the first tensor is stored. The second agent can attain or “dereference” the results of the manipulation of the first tensor by accessing the results using the pointer.

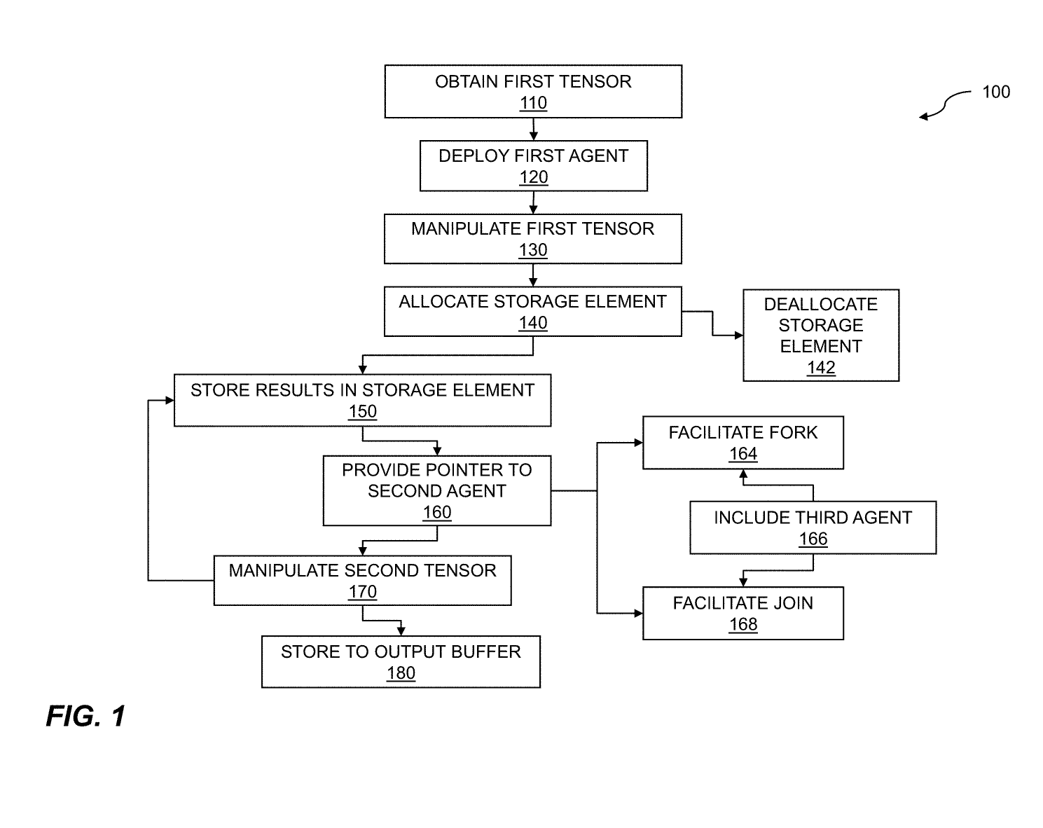

FIG. 1 is a flow diagram for tensor manipulation within a reconfigurable fabric using pointers. The flow 100 includes obtaining a first tensor 110 for processing on a reconfigurable fabric comprised of a plurality of processing elements, storage elements, and switching elements. The first tensor can include a plurality of arrays, a multidimensional matrix, and so on. The tensor can be uploaded by a user, obtained from a library, etc. The elements of the array can be configured as processing elements, storage elements, or switching elements by using a scheduling technique. The elements can be controlled by a rotating circular buffer, where the rotating circular buffer can include instructions that can be scheduled. In embodiments, the rotating circular buffer can be statically scheduled. The flow 100 includes deploying a first agent 120 on one or more of the plurality of processing elements of the reconfigurable fabric. The deploying the first agent of the one or more of the plurality of processing elements can include allocating storage elements, switching elements, and so on. The flow 100 includes manipulating the first tensor 130 by the first agent. The manipulating the first tensor can be based on the first tensor, tensor metadata, and other data. The manipulating the first tensor can include tensor operations such as tensor product, tensor contraction, raising a tensor index, lowering a tensor index, and so on.

The flow 100 includes allocating a storage element 140 by a session manager. The storage element can include a storage element within the reconfigurable fabric. In embodiments, the storage element can be coupled to the reconfigurable fabric. For the storage element within the reconfigurable fabric, the storage element coupled to the reconfigurable fabric, and other storage elements, the storing in the storage element can include direct memory access (DMA). The session manager can manage deployment of agents to a plurality of processing elements; providing of tensors, tensor metadata, and other data; the allocating of storage; etc. The flow 100 further includes deallocating the storage element 142 based on a tensor done signal. That is, when a tensor manipulation has been completed, and the results of the previous tensor manipulation are no longer required by one or more agents, the storage element can be deallocated or “freed” for use by other agents for storing and retrieving tensor manipulation results. In embodiments, the deallocating is based on a plurality of tensor done signals. When more than one agent accesses the contents of a storage element, then the session manager must wait for all agents requiring the stored data to indicate that they no longer require the contents of the storage element.

The flow 100 includes storing the results of the manipulating the first tensor in a storage element 150 which is external from the first agent. The storage element in which the results of the manipulating the first tensor are stored can be a storage element within the reconfigurable fabric. The storage element can include a transfer buffer between the first agent and the second agent within the reconfigurable fabric. In embodiments, the transfer buffer between the first agent and the second agent can include a storage element coupled to the reconfigurable fabric. Various storage techniques can be used for the storing. In embodiments, the storing in the storage element coupled to the reconfigurable fabric can include direct memory access (DMA). DMA techniques can be used for storing in other storage elements, including storage elements within the reconfigurable array.

The flow 100 includes providing a pointer to a second agent 160 deployed on one or more of the plurality of processing elements of the reconfigurable fabric, wherein the pointer identifies an address of the storage element at which the first tensor is stored. Providing a pointer can reduce computation resource demands because the pointer to a single copy of the contents of the storage element can be shared between pairs of agents, among pluralities of agents, and so on. The sharing the pointer reduces storage requirements to a single copy of the contents as opposed to multiple copies for each agent that requires access to the contents. The sharing the pointer can also reduce session management overhead since there is no need to identify, store, maintain, or otherwise manage multiple copies of the contents addressed by the pointer.

Other signaling techniques can be used for deallocating or releasing storage elements. In embodiments, the deallocating can include releasing, by the first agent, the results of the manipulating the first tensor, from the storage element, after the second agent issues the pointer done signal. A pointer done signal can indicate that an agent has accessed, manipulated, etc., the contents pointed to by the pointer. In embodiments, the second agent can issue the pointer done signal once the second agent has completed reading the first tensor. When a plurality of agents can access the contents pointed to by the pointer, multiple pointer done signals can be included. In embodiments, the pointer can be used to facilitate a fork operation 164 between the first agent and the second agent. A fork operation is one in which the manipulation results of the first agent can be sent to a second agent and other agents. In embodiments, the fork operation can further include at least a third agent 166 on one or more of the plurality of processing elements of the reconfigurable fabric. A fork operation can be used to eliminate duplicate effort and thus conserve computational resources. Instead of requiring two separate pipelines of agents, each of which includes the first agent, the first agent can be “shared” by the pipeline including the second agent and the pipeline including the third agent. Recall that a transfer buffer is used between the first agent and the second agent. In embodiments, the flow 100 can further include using a plurality of transfer buffers to facilitate the fork operation. A transfer buffer can be used between the first agent and the second agent; between the first agent and the third agent; and so on.

In embodiments, a pointer is used to facilitate a join operation 168 between the first agent and the second agent. A join operation is the converse of a fork operation. Where a fork operation can split a pipeline into two or more pipelines, a join operation can combine two or more pipelines into a single operation. The join operation is accomplished between the first agent, the second agent, and a further agent. The further agent can be an agent that would be common to the pipelines including the first agent and the second agent. The join operation can reduce redundancy, and by extension, computational resource utilization. The join operation can further include at least a third agent 166 on one or more of the plurality of processing elements of the reconfigurable fabric. Recall that signals can be used to control tensor manipulation. In the case of a join operation, multiple sources (agents) can be alerted that the agent performing the join operation has finished using the data. In embodiments, the join operation is accomplished using a return signal for each agent that is contributing data to the join operation.

The flow 100 further includes manipulating a second tensor 170 by the second agent. The manipulating the second tensor can be based on the second tensor, tensor metadata, and other data. The manipulating the first tensor can include tensor operations such as tensor product, tensor contraction, raising a tensor index, lowering a tensor index, and so on. The tensor metadata for each tensor can include tensor dimension, tensor element count, tensor radix points, tensor element precision, tensor element range, or tensor element classification. The flow 100 further includes storing the results of the manipulating the second tensor. The storing can use a storage element within the reconfigurable fabric, a storage element coupled to the reconfigurable fabric, and so on. The storing can use a DMA operation. In embodiments, the storing includes storing the results of the manipulating the second tensor in the storage element external from the first agent. The reuse of the storage element external from the first agent can occur once the storage element has been deallocated. In embodiments, the storing includes storing the second tensor to an output buffer 180, by the second agent. As with other storage elements, the output buffer can be a storage element within the reconfigurable fabric, a storage element coupled to the reconfigurable fabric, etc. The output buffer can be used to support downstream operations. Downstream operations can include Boolean operations, tensor operations, and so on. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

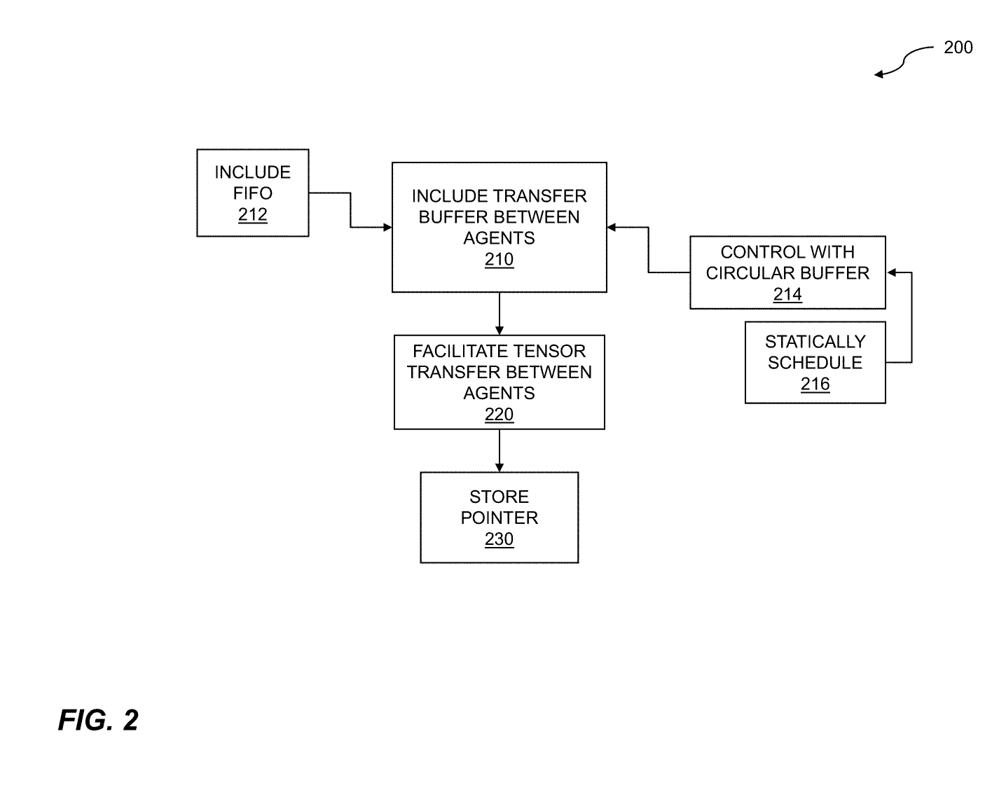

FIG. 2 is a flow diagram for inter-agent pointer storage. Tensor manipulation within a reconfigurable fabric can be performed using pointers. The one or more pointers can reference storage in which tensors, tensor metadata, and other data can be stored. Providing a pointer to storage enables the contents of the storage to be shared among a plurality of agents. By sharing the storage contents, only one copy of the contents is needed as opposed to requiring a discrete copy for each agent that uses the contents. The referencing the contents by pointer thus saves computational resources including storage, control, and so on. The reconfigurable fabric on which the agents can be deployed can include elements, where the elements can include processing elements, switching elements, storage elements, and so on. The agents can be deployed on the reconfigurable fabric using a pipeline technique. When a pipeline technique is used, the manipulation of the tensors and other data can generate results, intermediate results, etc. The results, intermediate results, instructions, kernels, and so on, can be stored in storage elements within the reconfigurable fabric, storage elements coupled to the reconfigurable fabric, etc.

The flow 200 includes using a transfer buffer between the first agent and the second agent 210 within the reconfigurable fabric. The transfer buffer can include a storage element within the reconfigurable fabric. The transfer buffer can include a storage element coupled to the reconfigurable fabric. The transfer buffer can include one or more storage locations. In embodiments, the transfer buffer can include a first in first out (FIFO) 212 storage technique. The transfer buffer can be located in direct communication with the processing elements of the first agent and the processing elements of the second agent. The processing elements and the storage elements can form a quad. In embodiments, the transfer buffer can be controlled by a rotating circular buffer 214. The rotating circular buffer can be included as an element within the reconfigurable fabric. The rotating circular buffer can include instructions, where the instructions can be scheduled. In embodiments, the rotating circular buffer is statically scheduled 216. The flow 200 includes facilitating tensor transfers between the first agent and the second agent 220. The tensor transfer between agents can be facilitated by the transfer buffer since the transfer buffer can hold manipulation results, intermediate manipulation results, and so on. The transfer buffer can “retime” data flow between and among agents when the period of time required for tensor manipulations by agents differs between and among agents. The flow 200 includes storing the pointer 230 that is provided. The stored pointer can then be shared between and among the agents that require access to the contents of the storage location pointed to by the pointer. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

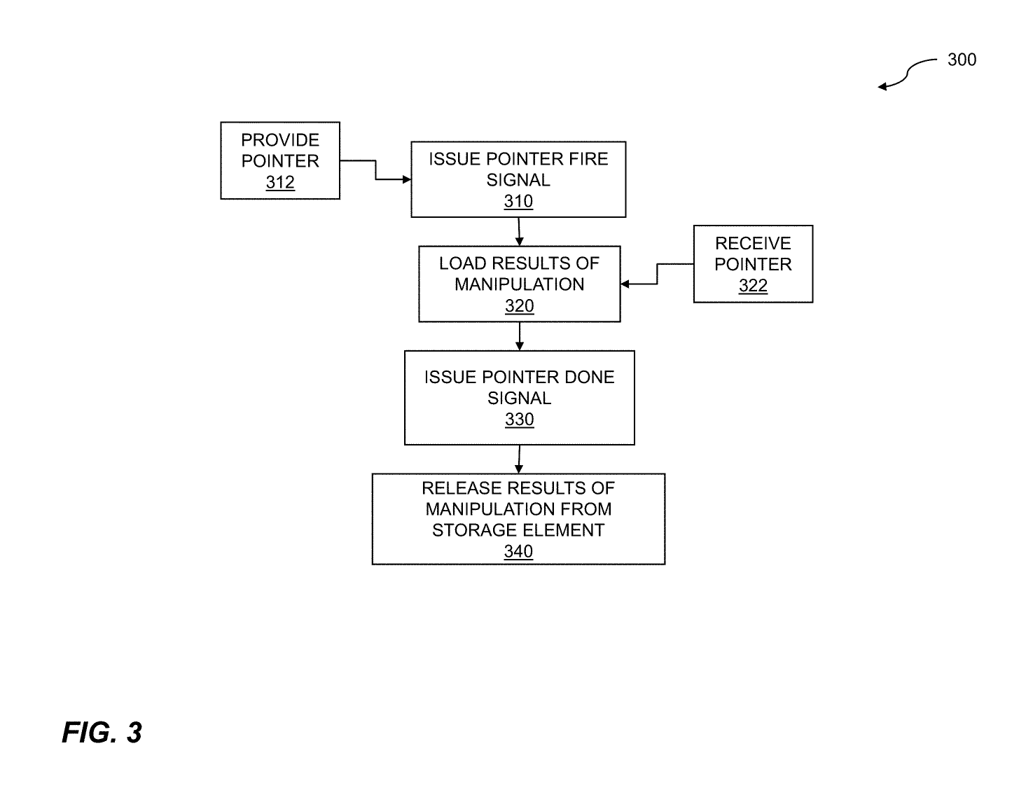

FIG. 3 is a flow diagram for signal issuing. Signals including tensor signals and pointer signals can be issued to control one or more pipelines of agents within a reconfigurable fabric. The tensor signals and the pointer signals can control tensor manipulation within a reconfigurable fabric using pointers. The flow 300 includes issuing a pointer fire signal 310 by the first agent to the second agent after the pointer is provided. The pointer fire signal can be used to indicate that a pointer has been determined based on storing tensors, tensor metadata, etc.; storing results including intermediate results; and the like. The providing can include providing a pointer 312 to a second agent deployed on one or more of the plurality of processing elements of the reconfigurable fabric, where the pointer can identify an address of the storage element at which the first tensor is stored. The storing can use a storage element external from the first agent. In embodiments, the storing can include using a storage element coupled to the reconfigurable fabric. The using the storage element coupled to the reconfigurable fabric can include direct memory access (DMA).

The flow 300 includes loading, by the first agent, the results of the manipulating 320 the first tensor after the second agent receives the pointer fire signal 322. The results of the manipulating the first tensor can be loaded into a storage element within the reconfigurable fabric, a storage element coupled to the reconfigurable fabric, and so on. The loading can include a direct memory access (DMA) technique. The second agent can receive the pointer fire signal through a switching element of the reconfigurable fabric since the reconfigurable fabric can be based on a data flow architecture. The flow 300 includes issuing a pointer done signal 330 by the second agent to the first agent after the second agent has completed manipulating the first tensor. The pointer done signal can also be issued as a result of agent 2 reading the data at the location referenced by the pointer provided by agent 1. The flow 300 includes releasing, by the first agent, the results of the manipulating the first tensor, from the storage element 340, after the second agent issues the pointer done signal. When agent 2 completes manipulation of the data pointed to by the pointer provided by agent 1, the contents of the storage element are out of synchronization, invalid, stale, or otherwise no longer needed. The storage element can be released so that the storage element may be used by agent 1 or another agent for further tensor manipulation. Various steps in the flow 300 may be changed in order, repeated, omitted, or the like without departing from the disclosed concepts. Various embodiments of the flow 300 can be included in a computer program product embodied in a non-transitory computer readable medium that includes code executable by one or more processors.

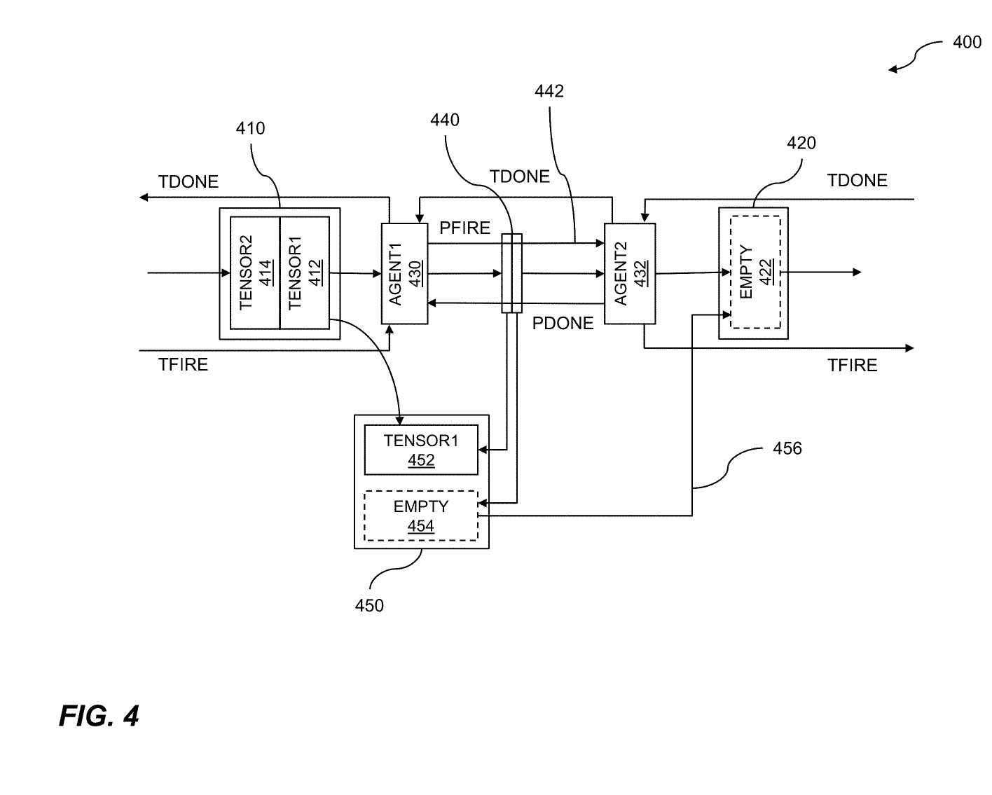

FIG. 4 illustrates tensor passing by pointers. Tensors, tensor metadata, and other data can be passed, between and among agents in one or more pipelines of agents, using pointers. Passing pointers is more advantageous than passing the data including tensor data because the pointer points to a location where the data is stored. The pointer, which can be thought of as an address for the storage location of the data, can be shared by the agents to which the data is to be provided. By sharing the pointer, a single copy of the data can be maintained rather than storing a copy of the data for each agent that requires the data. By sharing the pointer to the one copy of the data, storage requirements are reduced, as are the control requirements for locating, storing, and maintaining multiple copies of the data. The passing of pointers supports tensor manipulation within a reconfigurable fabric.

Tensors, tensor metadata, and other data, 400 can be passed between agents by reference. The reference, or pointer, allows a single copy of data to be shared between the agents without the need for each agent to maintain its own copy of the data. A pipeline of agents can manipulate tensors, tensor metadata, and other data. The pipeline of agents can be deployed on a plurality of processing elements of a reconfigurable fabric. A variety of operations including tensor operations can be performed, where the tensor operations can include computing tensor product, tensor contraction, raising a tensor index, lowering a tensor index, and so on. An agent pipeline is shown. Agent 1 430 and agent 2 432 form a pipeline. While a pipeline that includes two agents is shown, other numbers of agents can be included in a given pipeline. Each pair of agents can use a transfer buffer between the first agent and the second agent. The output of agent 1 is provided to agent 2 by providing a pointer to the output of agent 1. Input tensors can be held in memory locations, registers, transfer buffers, etc. In embodiments, a transfer buffer can be used between a first agent and a second agent within the reconfigurable fabric to facilitate tensor transfers between the first agent and the second agent. The memory locations, registers, buffers, etc., can use a storage element coupled to the reconfigurable fabric. In embodiments, the storage element coupled to the reconfigurable fabric includes direct memory access (DMA). In some embodiments, tensor pointers can facilitate transfer of data between agents where operations on a tensor are only partially completed.

An input buffer 410 is shown, where two tensors, tensor 1 412 and tensor 2 414 can be loaded for processing by a pipeline of two or more of agents. In some embodiments, multiple buffers, including multiple FIFOs, can provide inputs to an agent. Other buffers can include an intermediate or transfer buffer 440, and an output buffer 420. Other output buffers can be included, where the other output buffers can include output buffers from other pipelines of agents. The input buffers, intermediate buffers, and output buffers can store tensors, tensor metadata, and other data. In example 400, input buffer 410 can include tensor 1 412 and tensor 2 414. Tensor 1 and tensor 2 can be loaded before tensor manipulation by the pipeline of agents, here agent 1 and agent 2. An intermediate buffer 440 can store intermediate data, can point to data such as tensor 1 452 in transfer buffer 450, etc. An output buffer 420 can include results from tensor operations (not shown) performed by agent 2 432, initial data such as empty 422, etc. Data such as tensor 1 452 or a pointer to tensor 1 can be stored in transfer buffer 450, where the transfer buffer can include a storage element, storage coupled to the reconfigurable fabric, and so on. A second pointer storage element 454 is initially empty. The transfer buffer can store tensors, tensor metadata, intermediate data, and the like. A pointer 456 from the transfer buffer 450 can be sent to output buffer 420 or other buffers.

An agent pipeline using pointers can use control signals including tensor fire tfire, tensor done tdone, pointer fire pfire, and pointer done pdone. When pointers are provided to pipelines of agents, a pfire signal can be shared between agents. In 400, the pfire signal 442 from agent 1 is provided to agent 2. When an agent has finished with a given pointer, the agent responds with a pdone signal. A pdone signal is shown to return from agent 2 to agent 1. Tensor fire and tensor done signals can also be used, where the tensor fire and tensor done signals can be sent from an agent to another agent. A tensor done tdone signal can be received from the downstream agent. The tdone signal can be used by the receiving agent to indicate to the sending agent that the tensor has been read, processed, and so on. The tdone signal can be sent by the ultimate agent within a pipeline of agents. The tdone signal can be sent based on the agent sending the tdone signal after performing an operation such as a tensor operation, a tensor read operation, etc. When a downstream agent sends a tdone signal, the upstream agent can perform an operation, store new data, and so on.

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

A pointer can be a reference to a storage element in which information such as a tensor, tensor metadata, etc., can be stored. The pointer can serve as the address of the particular storage element. Tensors can be passed from agent to agent within a reconfigurable fabric by sharing a pointer. The pointer can be used to access the tensor, etc., without having to copy the data to each agent that requires access to the data. In a first usage example, a first agent can copy the input tensor from its input buffer to a storage element within the reconfigurable fabric. When the first agent is deployed on processing elements of the reconfigurable fabric, a session manager allocates storage for use exclusively by the first agent. A local copy of a given tensor will remain resident and available to the first agent until the first agent overwrites the local copy of the tensor. When the first agent has completed manipulation of the first tensor, the first agent provides a pointer to its storage element in which the tensor is stored. To facilitate the processing of tensors, tensor metadata, and other data, control signals can be used. In embodiments, the control signals include fire signals and done signals. A fire signal, pfire, can be a pointer signal used to inform downstream agents that the pointer to the location of a tensor or other data has been provided. A done signal, pdone, can be a pointer signal used to inform an upstream agent that the data pointed to by the pointer has been manipulated and is no longer needed.

Pointers can be used to facilitate operations including fork operations and join operations. A fork occurs when the output of an agent is provided to two or more downstream agents. A join operation occurs when the outputs of two or more agents are provided to one downstream agent. For a fork operation, which can result from a fork in a graph, two or more copies of a pointer can be provided to downstream agents. The downstream agents can manipulate the same copy of the data stored in the location of the storage element referenced by the pointer. For a join operation, which can result from a join in a graph, a copy of a pointer is provided by each upstream agent to the downstream agent. The downstream agent can manipulate the copy of the data stored at each location of the storage elements referenced by each pointer.

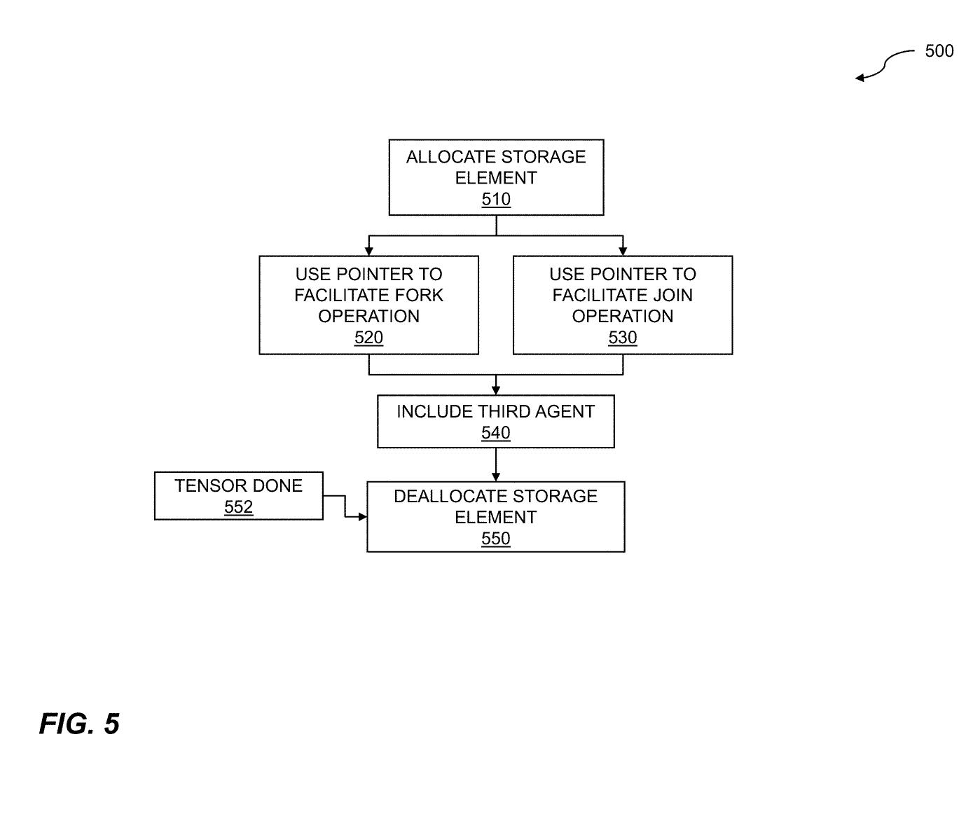

FIG. 5 is flow diagram for storage allocation. Storage allocation can be used when storing results of manipulating a tensor or other data. The storage can include a storage element external from the agent, where the storage element can include a storage element of a reconfigurable fabric. In embodiments, the storage element can be coupled to the reconfigurable fabric and can include direct memory access (DMA). The storage allocation, and the deallocation of the storage when an operation is complete, can support tensor manipulation within a reconfigurable fabric using pointers. The flow 500 includes allocating the storage element 510 by a session manager. The storage element can be a storage element within a reconfigurable fabric, a storage element coupled to the reconfigurable fabric, and so on. In embodiments, the storing in the storage element coupled to the reconfigurable fabric can include direct memory access (DMA). The session manager can control the flow of data such as tensors and tensor metadata through a pipeline of agents. The flow 500 includes using a pointer, where the pointer can be used to facilitate a fork operation 520 between a first agent and a second agent. A pointer can be used to provide the data to a plurality of agents without having to write and maintain multiple copies of the same data. Using the pointer can reduce computational overhead by reducing storage and control requirements for storing and maintaining the data.

The flow 500 includes using a pointer, where the pointer is used to facilitate a join operation 530 between the first agent and the second agent. A join operation can take as inputs pointers to the outputs from two or more agents. The join operation can “join” or merge two or more pipelines into one pipeline. The joining can be used to reduce redundancy in the agent pipelines. The flow 500 further includes at least a third agent 540 on one or more of the plurality of processing elements of the reconfigurable fabric. The third agent can be included for a fork operation and for a join operation. In embodiments, the fork operation can further include at least a third agent on one or more of the plurality of processing elements of the reconfigurable fabric. The third agent can receive as an input the same data that is provided to the second agent. In other embodiments, the join operation can further include at least a third agent on one or more of the plurality of processing elements of the reconfigurable fabric. The flow 500 includes deallocating the storage element 550 based on a tensor done signal 552. The storage element such as a storage element within a reconfigurable fabric, a storage element coupled to the reconfigurable fabric, and so on, can be deallocated or “freed” when the data such as a tensor stored in the storage element is no longer needed. The tensor that can be stored can be read, manipulated, and so on, by another agent such as agent 2, agent 3, etc. When the operation of tensor manipulation or reading is complete, the data is no longer needed. Indication that the operation of reading, manipulation, etc., is complete is indicated by the tensor done signal 552. In embodiments, the deallocating can be based on a plurality of tensor done signals. Various steps in the flow 500 may be changed in order, repeated, omitted, or the like without departing from the disclosed concepts. Various embodiments of the flow 500 can be included in a computer program product embodied in a non-transitory computer readable medium that includes code executable by one or more processors.

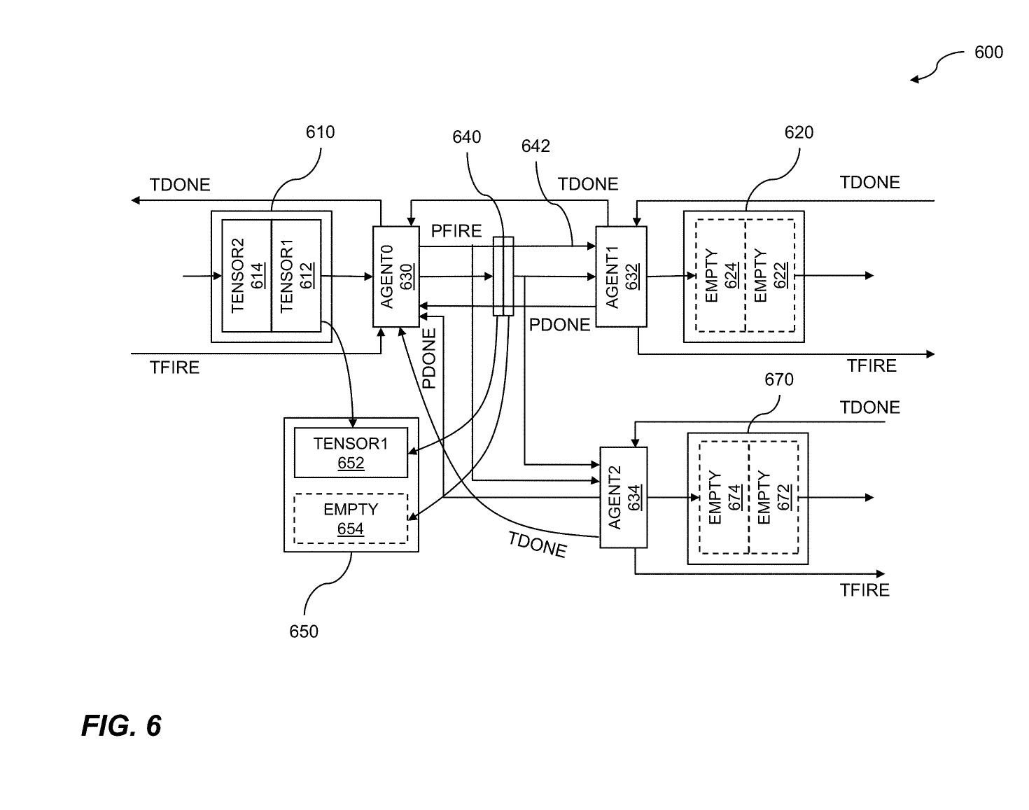

FIG. 6 is an example illustrating forking of pointers to an agent. The forking of pointers to agents can be used for providing one or more pointers to a plurality of agents, where the plurality of agents can take as input a given tensor. In embodiments, a pointer can include a pointer head and a pointer tail. The pointer head and the pointer tail can also be provided along with providing the pointer. The forking of pointers to agents can be used for tensor manipulation within a reconfigurable fabric using pointers. The pointers can be provided so that all agents that require access to given data, such as a tensor, tensor metadata, and so on, can point to a single buffer, memory location, storage element, etc., instead of having to maintain a plurality of copies of the same data. As a result, less storage and control are required since only one copy of the data need be maintained. One or more tensors can be manipulated by agents. Depending on the data manipulation operations such as tensor manipulations that can be applied to the tensors, one or more pipelines of agents can be used. A given tensor operation can include a tensor product, a tensor contraction, raising a tensor index, lowering a tensor index, and so on. Agent pipelines including forking of pointers are shown 600. Two agent pipelines are shown. Agent 0 630 and agent 1 632 form one pipeline, while agent 0 630 and agent 2 634 form a second pipeline. The two pipelines include agent 0 in each pipeline. While pipelines that include two agents are shown, other numbers of agents can be included in one or more pipelines, forked pipelines, and the like. The output of agent 0 is provided or “forked” to both agent 1 and agent 2 by providing a pointer to the output of agent 0. While two pipelines including a fork are shown, other numbers of pipelines can be included. When two or more pipelines merge, the pipelines are said to “join”.

Input tensors can be held in registers, buffers, etc. The one or more tensors can be held in one or more transfer buffers. In embodiments, a transfer buffer can be used between a first agent and a second agent within the reconfigurable fabric to facilitate tensor transfers between the first agent and the second agent. The registers, buffers, memory, and the like, can use a storage element coupled to the reconfigurable fabric. In embodiments, the using a storage element, including the storage element coupled to the reconfigurable fabric, includes direct memory access (DMA). An input buffer 610 is shown, where two tensors, tensor 1 612 and tensor 2 614 can be loaded for processing by one or more pipelines of agents. Other buffers can include an intermediate or transfer buffer 640 and output buffers 620 and 670. Other output buffers can be included, where the other output buffers can include output buffers from pipelines that include forks or joins, pipelines independent of other pipelines, and so on. The input buffers, intermediate buffers, and output buffers, can store tensors, tensor metadata, and other data. In example 600, the input buffer 610 can include tensor 1 612 and tensor 2 614. Intermediate buffer 640 can store intermediate data, can point to data such as tensor 1 652 in transfer buffer 650, etc. While one intermediate buffer 640 is shown, a plurality of intermediate buffers can be used when the output of an agent is forked to the inputs of multiple downstream agents. Output buffer 620 can include results from tensor operations (not shown) performed by agent 1 632, initial data such as empty 622 and empty 624, etc. Output buffer 670 can include results from tensor operations (not shown) performed by agent 2 634, initial data such as empty 672 and empty 674, and the like.

Data such as tensor 1 652 or a pointer to tensor 1 can be stored in transfer buffer 650, where the transfer buffer can include a storage element, storage coupled to the reconfigurable fabric, and so on. A second pointer storage element 654 is initially empty. The transfer buffer can store tensors, tensor metadata, intermediate data, and the like. An agent pipeline using pointers is described above, where control signals include tensor fire tfire, tensor done tdone, pointer fire pfire, and pointer done pdone. When forking of pointers is used to distribute data to pipelines of agents, a pfire signal can be shared between and among agents. In 600, the pfire signal 642 from agent 0 is shared with agent 1 and agent 2. When agents have finished with a given pointer, the agents respond with a pdone signal. Pdone signals are shown to return from agent 1 to agent 0, and from agent 2 to agent 0. Tensor fire and tensor done signal can also be used, where the tensor fire signal from an agent can be sent to one or more other agents, and one or more tensor done tdone signals can be received from the downstream agents. The tdone signal can be used by one or more receiving agents to indicate to the sending agent that the tensor has been read, processed, and so on. The tdone signals can be sent by the ultimate agent within a pipeline of agents. The tdone signal can be sent based on the agent sending the tdone signal after performing an operation such as a tensor operation. The operation can include reading the data. When a downstream agent sends a tdone signal, the upstream agent can perform an operation, store new data, and so on.

Data flow processors can be implemented within a reconfigurable fabric and can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can process a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a negative value of (1 plus the Manhattan distance from a given PE in a cluster to the end of the cluster). A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuration mode for a cluster can include propagating a signal. Clusters can be preprogrammed to enter configuration mode. Various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform such as a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of an entire system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator or a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a data flow graph.

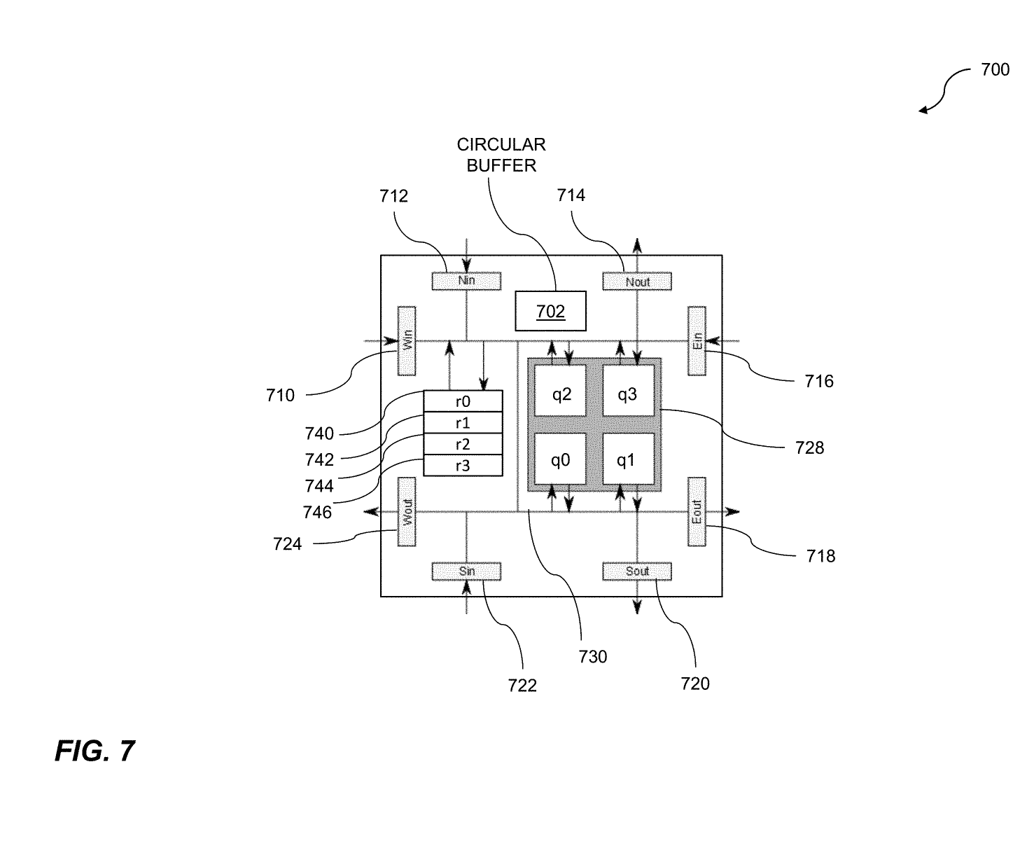

FIG. 7 shows a cluster for coarse-grained reconfigurable processing. The cluster for coarse-grained reconfigurable processing 700 can be used for tensor manipulation within a reconfigurable fabric using pointers. Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The cluster 700 comprises a circular buffer 702. The circular buffer 702 can be referred to as a main circular buffer or a switch-instruction circular buffer. In some embodiments, the cluster 700 comprises additional circular buffers corresponding to processing elements within the cluster. The additional circular buffers can be referred to as processor instruction circular buffers. The example cluster 700 comprises a plurality of logical elements, configurable connections between the logical elements, and a circular buffer 702 controlling the configurable connections. The logical elements can further comprise one or more of switching elements, processing elements, or storage elements. The example cluster 700 also comprises four processing elements—q0, q1, q2, and q3. The four processing elements can be collectively referred to as a “quad,” and can be jointly indicated by a grey reference box 728. In embodiments, there is intercommunication among and between each of the four processing elements. In embodiments, the circular buffer 702 controls the passing of data to the quad of processing elements 728 through switching elements. In embodiments, the four processing elements 728 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 700 can further comprise storage elements coupled to the configurable connections. As shown, the cluster 700 comprises four storage elements—r0 740, r1 742, r2 744, and r3 746. The cluster 700 further comprises a north input (Nin) 712, a north output (Nout) 714, an east input (Ein) 716, an east output (Eout) 718, a south input (Sin) 722, a south output (Sout) 720, a west input (Win) 710, and a west output (Wout) 724. The circular buffer 702 can contain switch instructions that implement configurable connections. For example, an instruction effectively connects the west input 710 with the north output 714 and the east output 718 and this routing is accomplished via bus 730. The cluster 700 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 702. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a collision. For example, in some instances the preprocessor can change an instruction placing data on the west output 724 to an instruction placing data on the south output 720, such that the data can be output on both output ports within the same pipeline cycle. In a case where data needs to travel to a cluster that is both south and west of the cluster 700, it can be more efficient to send the data directly to the south output port rather than to store the data in a register first and then send the data to the west output on a subsequent pipeline cycle.

An L2 switch interacts with the instruction set. A switch instruction typically has a source and a destination. Data is accepted from the source and sent to the destination. There are several sources (e.g. any of the quads within a cluster, any of the L2 directions (North, East, South, West), a switch register, one of the quad RAMs (data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in excessive instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A” to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing access to them to be shared by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

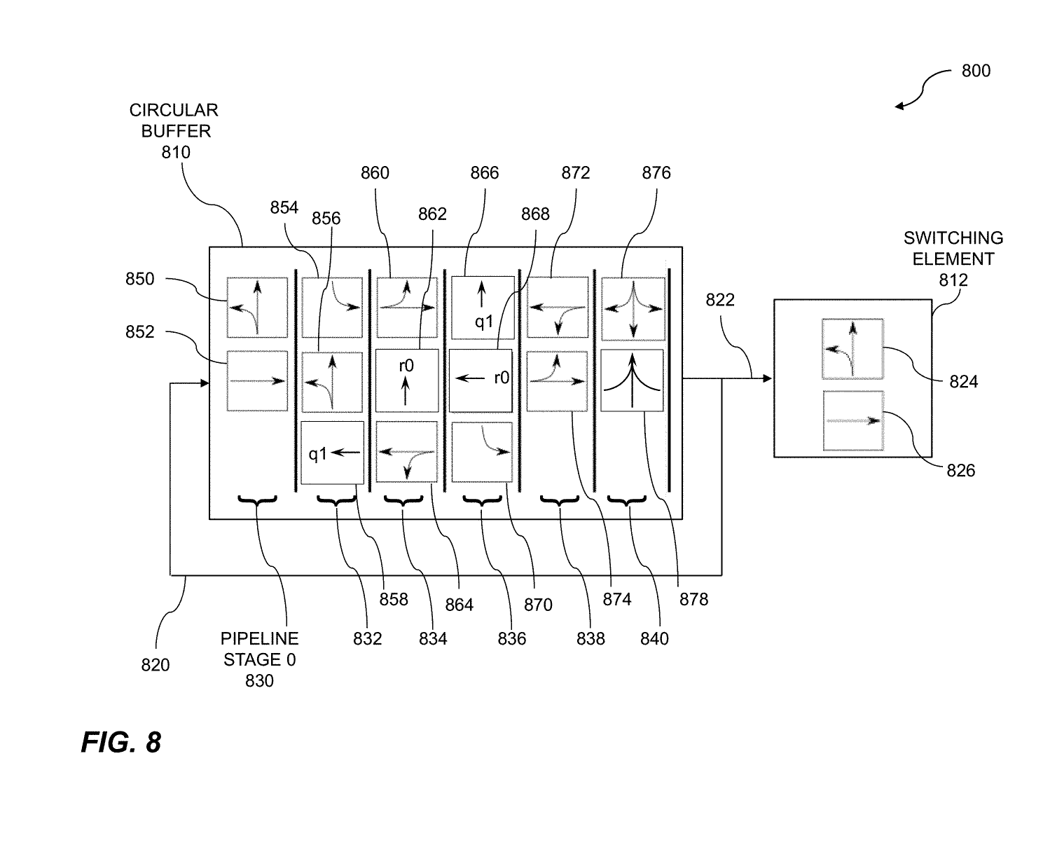

FIG. 8 illustrates a block diagram 800 of a circular buffer. The circular buffer of block diagram 800 can include a switching element 812 corresponding to the circular buffer 810. The circular buffer and the corresponding switching element can be used in part for pipelined tensor manipulation within a reconfigurable fabric. Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 800 describes a processor-implemented method for data manipulation. The circular buffer 810 contains a plurality of pipeline stages. Each pipeline stage contains one or more instructions, up to a maximum instruction depth. In the embodiment shown in FIG. 8, the circular buffer 810 is a 6×3 circular buffer, meaning that it implements a six-stage pipeline with an instruction depth of up to three instructions per stage (column). Hence, the circular buffer 810 can include one, two, or three switch instruction entries per column. In some embodiments, the plurality of switch instructions per cycle can comprise two or three switch instructions per cycle. However, in certain embodiments, the circular buffer 810 supports only a single switch instruction in a given cycle. In the example block diagram 800 shown, pipeline stage 0 830 has an instruction depth of two instructions 850 and 852. Though the remaining pipeline stages 1-5 are not textually labeled in the example block diagram 800, the stages are indicated by callouts 832, 834, 836, 838, and 840. Pipeline stage 1 832 has an instruction depth of three instructions 854, 856, and 858. Pipeline stage 2 834 has an instruction depth of three instructions 860, 862, and 864. Pipeline stage 3 836 also has an instruction depth of three instructions 866, 868, and 870. Pipeline stage 4 838 has an instruction depth of two instructions 872 and 874. Pipeline stage 5 840 has an instruction depth of two instructions 876 and 878. In embodiments, the circular buffer 810 includes 64 columns. During operation, the circular buffer 810 rotates through configuration instructions. The circular buffer 810 can dynamically change operation of the logical elements based on the rotation of the circular buffer. The circular buffer 810 can comprise a plurality of switch instructions per cycle for the configurable connections.

The instruction 852 is an example of a switch instruction. In embodiments, each cluster has four inputs and four outputs, each designated within the cluster's nomenclature as “north,” “east,” “south,” and “west” respectively. For example, the instruction 852 in the diagram 800 is a west-to-east transfer instruction. The instruction 852 directs the cluster to take data on its west input and send out the data on its east output. In another example of data routing, the instruction 850 is a fan-out instruction. The instruction 850 instructs the cluster to take data from its south input and send out on the data through both its north output and its west output. The arrows within each instruction box indicate the source and destination of the data. The instruction 878 is an example of a fan-in instruction. The instruction 878 takes data from the west, south, and east inputs and sends out the data on the north output. Therefore, the configurable connections can be considered to be time multiplexed.

In embodiments, the clusters implement multiple storage elements in the form of registers. In the example block diagram 800 shown, the instruction 862 is a local storage instruction. The instruction 862 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 858 is a processing instruction. The instruction 858 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 800 shown, the circular buffer 810 rotates instructions in each pipeline stage into switching element 812 via a forward data path 822, and also back to a pipeline stage 0 830 via a feedback data path 820. Instructions can include switching instructions, storage instructions, and processing instructions, among others. The feedback data path 820 can allow instructions within the switching element 812 to be transferred back to the circular buffer. Hence, the instructions 824 and 826 in the switching element 812 can also be transferred back to pipeline stage 0 as the instructions 850 and 852. In addition to the instructions depicted on FIG. 8, a no-op instruction can also be inserted into a pipeline stage. In embodiments, a no-op instruction causes execution to not be performed for a given cycle. In effect, the introduction of a no-op instruction can cause a column within the circular buffer 810 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 858, assuming that the processor q1 was previously in a sleep state. In embodiments, when the instruction 858 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 866. In the case of the instruction 866, data from the processor q1 is moved to the north output. In some embodiments, if Xs have been placed into the processor q1, such as during the instruction 858, then Xs would be retrieved from the processor q1 during the execution of the instruction 866 and applied to the north output of the instruction 866.

A collision occurs if multiple instructions route data to a particular port in a given pipeline stage. For example, if instructions 852 and 854 are in the same pipeline stage, they will both send data to the east output at the same time, thus causing a collision since neither instruction is part of a time-multiplexed fan-in instruction (such as the instruction 878). To avoid potential collisions, certain embodiments use preprocessing, such as by a compiler, to arrange the instructions in such a way that there are no collisions when the instructions are loaded into the circular buffer. Thus, the circular buffer 810 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 862), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will make sure the memory bit is reset to 0 and thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

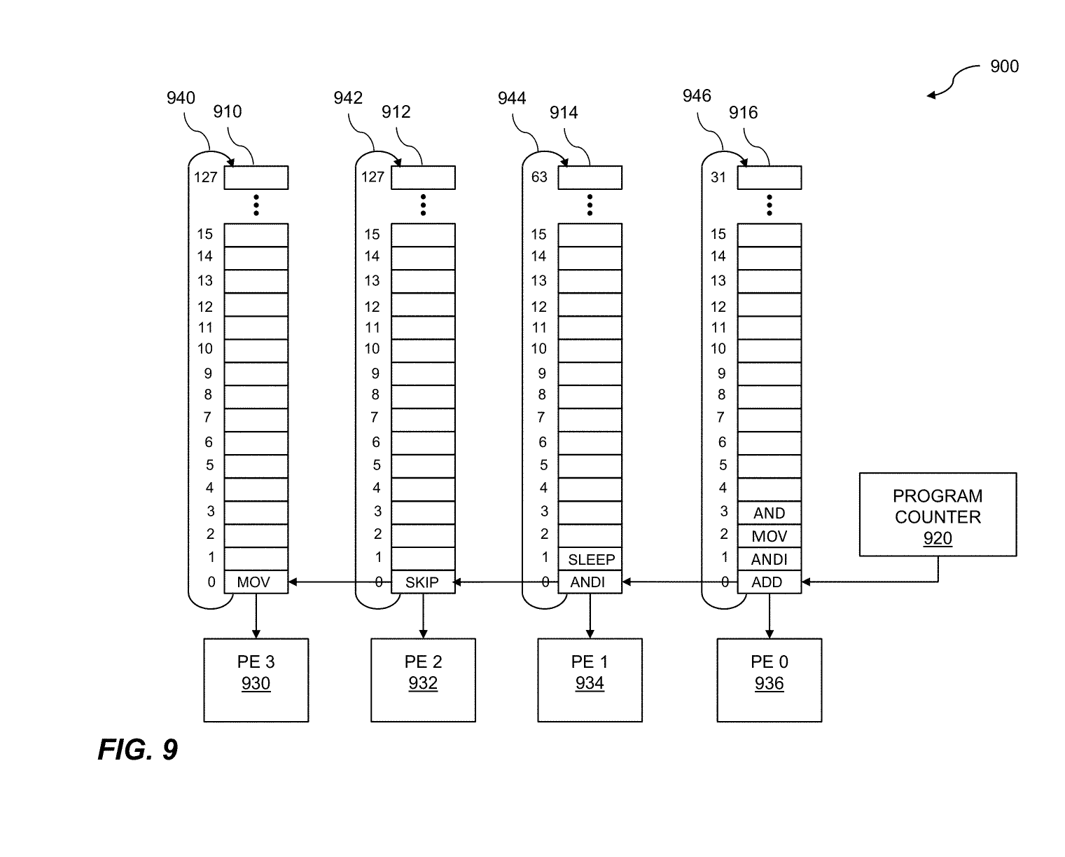

FIG. 9 illustrates a circular buffer and processing elements. The figure shows a diagram 900 indicating example instruction execution for processing elements. The instruction execution can include instructions for tensor radix point calculation in a neural network. A circular buffer 910 feeds a processing element 930. A second circular buffer 912 feeds another processing element 932. A third circular buffer 914 feeds another processing element 934. A fourth circular buffer 916 feeds another processing element 936. These circular buffers are shown with lengths of 128, 64, and 32 entries, but various lengths are possible. The four processing elements 930, 932, 934, and 936 can represent a quad of processing elements. In embodiments, the processing elements 930, 932, 934, and 936 are controlled by instructions received from the circular buffers 910, 912, 914, and 916. The circular buffers can be implemented using feedback paths 940, 942, 944, and 946, respectively. In embodiments, the circular buffer can control the passing of data to a quad of processing elements through switching elements, where each of the quad of processing elements is controlled by four other circular buffers (as shown in the circular buffers 910, 912, 914, and 916) and where data is passed back through the switching elements from the quad of processing elements where the switching elements are again controlled by the main circular buffer. In embodiments, a program counter 920 is configured to point to the current instruction within a circular buffer. In embodiments with a configured program counter, the contents of the circular buffer are not shifted or copied to new locations on each instruction cycle. Rather, the program counter 920 is incremented in each cycle to point to a new location in the circular buffer. The circular buffers 910, 912, 914, and 916 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 910 and 912 have a length of 128 instructions, the circular buffer 914 has a length of 64 instructions, and the circular buffer 916 has a length of 32 instructions, but other circular buffer lengths are also possible. In some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 9, different circular buffers can have different instruction sets within them. For example, the first circular buffer 910 contains a MOV instruction. The second circular buffer 912 contains a SKIP instruction. The third circular buffer 914 contains a SLEEP instruction and an ANDI instruction. The fourth circular buffer 916 contains an AND instruction, a MOVE instruction, an ANDI instruction, and an ADD instruction. The operations performed by the processing elements 930, 932, 934, and 936 are dynamic and can change over time, based on the instructions loaded into the respective circular buffers. As the circular buffers rotate, new instructions can be executed by the respective processing element.

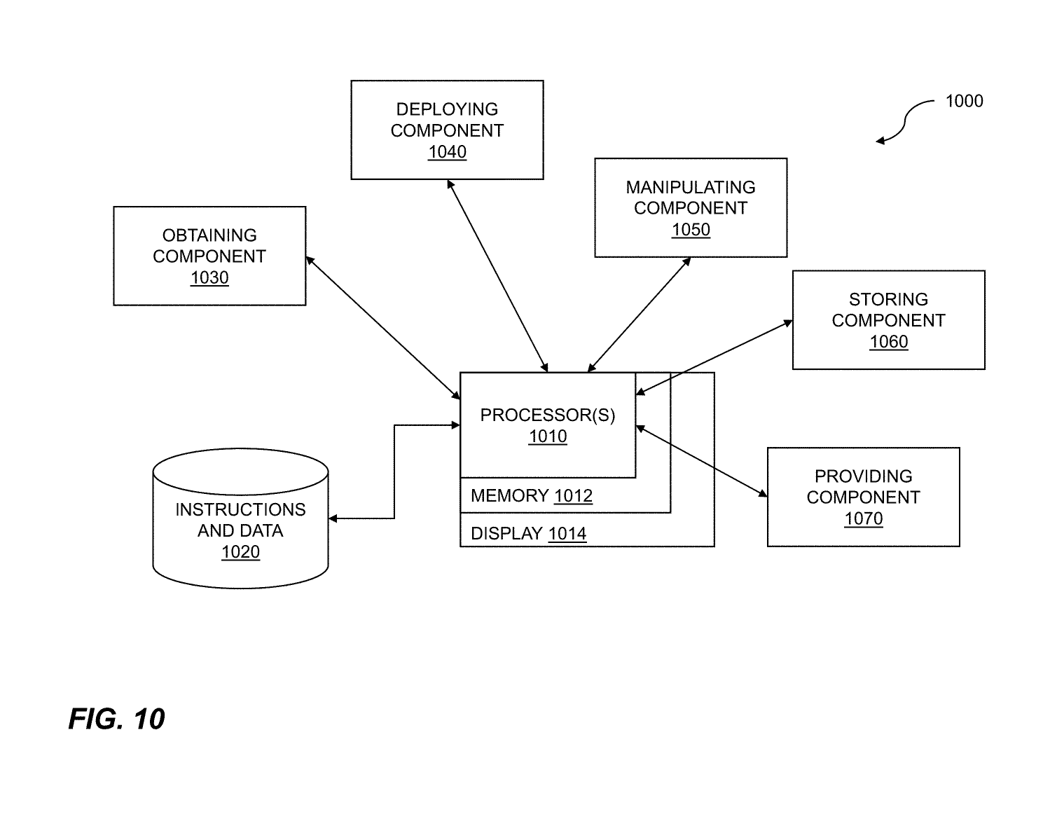

FIG. 10 is a system for tensor manipulation within a reconfigurable fabric using pointers. The system 1000 can include one or more processors 1010 coupled to a memory 1012 which stores instructions. The system 1000 can include a display 1014 coupled to the one or more processors 1010 for displaying data, intermediate steps, instructions, and so on. In embodiments, one or more processors 1010 are attached to the memory 1012 where the one or more processors, when executing the instructions which are stored, are configured to: obtain a first tensor for processing on a reconfigurable fabric comprised of a plurality of processing elements, storage elements, and switching elements; deploy a first agent on one or more of the plurality of processing elements of the reconfigurable fabric; manipulate the first tensor by the first agent; store the results of the manipulating the first tensor in a storage element external from the first agent; provide a pointer to a second agent deployed on one or more of the plurality of processing elements of the reconfigurable fabric, wherein the pointer identifies an address of the storage element at which the first tensor is stored; and process the first tensor by the second agent.

The system 1000 can include a collection of instructions and data 1020. The instructions and data 1020 may be stored in a database, one or more statically linked libraries, one or more dynamically linked libraries, precompiled headers, source code, flow graphs, kernels, agents, or other suitable formats. The instructions can include instructions for tensor manipulation within a reconfigurable fabric using tensors. The instructions can include metadata that is determined for each tensor. The instructions can include a static schedule for controlling a rotating circular buffer, where the rotating circular buffer can be used to control a storage element interposed between the first agent and the second agent. The system 1000 can include an obtaining component 1030. The obtaining component 1030 can include functions and instructions for obtaining a first tensor for processing on a reconfigurable fabric comprised of a plurality of processing elements, storage elements, and switching elements. The first input tensor can include fixed-point numerical representations and can include tensor metadata. The system 1000 can include a deploying component 1040. The deploying component 1040 can include functions and instructions for deploying a first agent on one or more of the plurality of processing elements of the reconfigurable fabric.

The system 1000 can include a manipulating component 1050. The manipulating component 1050 can include functions and instructions manipulating the first tensor by the first agent. The manipulating the first tensor by the first agent can include a tensor operation such as tensor product, a tensor contraction, raising a tensor index, lowering a tensor index, and so on. The system 1000 can include a storing component 1060. The storing component can store the results of the manipulating the first tensor in a storage element external from the first agent. In embodiments, the storing can include using a transfer buffer between the first agent and another agent within the reconfigurable fabric. The transfer buffer can include a storage element within the reconfigurable fabric. In other embodiments, the storing can include storing in a storage element coupled to the reconfigurable fabric. The storing can be realized by using a processing element to obtain data from the first agent and to store the data into the storage element coupled to the reconfigurable array. In further embodiments, the storing in the storage element coupled to the reconfigurable fabric includes direct memory access (DMA). The system 1000 can include a providing component 1070. The providing component 1070 can include functions and instructions for providing a pointer to a second agent deployed on one or more of the plurality of processing elements of the reconfigurable fabric, where the pointer identifies an address of the storage element at which the first tensor is stored. The providing component can include functions and instructions for issuing a pointer fire signal by the first agent to the second agent after the pointer is provided.

The system 1000 can include a computer program product embodied in a non-transitory computer readable medium for tensor manipulation, the computer program product comprising code which causes one or more processors to perform operations of: obtaining a first tensor for processing on a reconfigurable fabric comprised of a plurality of processing elements, storage elements, and switching elements; deploying a first agent on one or more of the plurality of processing elements of the reconfigurable fabric; manipulating the first tensor by the first agent; storing the results of the manipulating the first tensor in a storage element external from the first agent; providing a pointer to a second agent deployed on one or more of the plurality of processing elements of the reconfigurable fabric, wherein the pointer identifies an address of the storage element at which the first tensor is stored; and processing the first tensor by the second agent.

Embodiments of the disclosed invention include a tensor manipulation apparatus for processing a tensor on a reconfigurable fabric comprised of a plurality of processing elements, storage elements, and switching elements, the apparatus comprising: means for deploying a first agent on one or more of a plurality of processing elements of the reconfigurable fabric; means for manipulating the tensor by the first agent, and storing results of the manipulating the tensor in a storage element external from the first agent; and means for providing a pointer to a second agent deployed on one or more of the plurality of processing elements of the reconfigurable fabric, wherein the pointer identifies an address of the storage element at which the tensor is stored.

The deploying a first agent can be preferably performed by a session manager with connections to the reconfigurable fabric. The session manager can execute on processors that are not part of the reconfigurable fabric proper, that is, that are not on the clusters of the fabric. The session manager can execute on a session host, which can be a commercially available or customized computer or server system that connects to the reconfigurable fabric. In some embodiments, the session manager executes on processors integrated within the reconfigurable fabric.

The manipulating the tensor by the first agent can be preferably performed by the elements of the reconfigurable fabric. The elements can comprise clusters of customized reconfigurable fabric processor elements, storage elements, and/or switching elements. In embodiments, the elements can comprise commercially available processors, storage, and/or switches, such as DSP processors, RISC processors, CISC processors, embedded processors, GPU processors, customized ASIC processors, FPGA processors, and the like. In embodiments, the session manager can preferably control the allocation and use of a storage element external to the processor on which the first agent is resident. The storage element can comprise DRAM storage, SRAM storage, NVRAM storage, memory stacks, SSD storage, PCM storage, register file storage, FIFO storage, integrated ASIC storage, HMC/HBM memories, DDR memories, and the like.

The providing a pointer to a second agent can be preferably performed by the first agent through the storage element. The pointer can be contained in a location in the storage element which is read by the second agent. The pointer can be contained in local memory that is shareable between the first agent and the second agent. The pointer can be provided from the first agent to the second agent over a data path within the reconfigurable fabric. The pointer can be provided by a bus that is shared within the reconfigurable fabric. The pointer can be provided by a dedicated signal connected to, but from without, the reconfigurable fabric. The pointer can be provided by electrical signaling, optical signaling, and so on. In embodiments, the pointer can be managed by the session manager.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for tensor manipulation comprising:
obtaining a first tensor for processing on a reconfigurable fabric comprised of a plurality of processing elements, storage elements, and switching elements;
deploying a first agent on one or more of the plurality of processing elements of the reconfigurable fabric;
manipulating the first tensor by the first agent;
storing results of the manipulating the first tensor in a storage element external from the first agent;
providing a pointer to a second agent deployed on one or more of the plurality of processing elements of the reconfigurable fabric, wherein the pointer identifies an address of the storage element at which the first tensor is stored; and
processing the first tensor by the second agent.

2. The method of claim 1 further comprising using a transfer buffer between the first agent and the second agent within the reconfigurable fabric to facilitate tensor transfers between the first agent and the second agent.

3. The method of claim 2 wherein the transfer buffer facilitates the tensor transfers by storing the pointer that was provided.

4-6. (canceled)

7. The method of claim 2 wherein the transfer buffer between the first agent and the second agent comprises a storage element coupled to the reconfigurable fabric.

8. (canceled)

9. The method of claim 1 further comprising issuing a pointer fire signal by the first agent to the second agent after the pointer is provided.

10. The method of claim 9 further comprising loading, by the first agent, results of the manipulating the first tensor, after the second agent receives the pointer fire signal.

11. The method of claim 1 further comprising issuing a pointer done signal by the second agent to the first agent after the second agent has completed manipulating the first tensor.

12. The method of claim 11 further comprising releasing, by the first agent, results of the manipulating the first tensor, from the storage element, after the second agent issues the pointer done signal.

13. The method of claim 12 wherein the second agent issues the pointer done signal subsequent to the second agent having completed reading the first tensor.

14. The method of claim 1 further comprising allocating the storage element by a session manager.

15. The method of claim 14 further comprising deallocating the storage element based on a tensor done signal.

16. (canceled)

17. The method of claim 1 wherein the pointer is used to facilitate a fork operation between the first agent and the second agent.

18. The method of claim 17 wherein the fork operation further includes at least a third agent on one or more of the plurality of processing elements of the reconfigurable fabric.

19. (canceled)

20. The method of claim 1 wherein the pointer is used to facilitate a join operation between the first agent and the second agent.

21. The method of claim 20 wherein the join operation further includes at least a third agent on one or more of the plurality of processing elements of the reconfigurable fabric.

22. The method of claim 21 wherein the join operation is accomplished between the first agent, the second agent, and a further agent.

23. (canceled)

24. The method of claim 1 further comprising manipulating a second tensor by the second agent.

25. The method of claim 24 further comprising storing results of the manipulating the second tensor in the storage element external from the first agent.

26. The method of claim 25 further comprising storing the second tensor to an output buffer, by the second agent.

27. (canceled)

28. The method of claim 1 wherein the plurality of processing elements is controlled by a plurality of rotating circular buffers.

29. (canceled)

30. The method of claim 1 wherein tensor metadata is included with each tensor.

31. (canceled)

32. A computer program product embodied in a non-transitory computer readable medium for tensor manipulation, the computer program product comprising code which causes one or more processors to perform operations of:
obtaining a first tensor for processing on a reconfigurable fabric comprised of a plurality of processing elements, storage elements, and switching elements;
deploying a first agent on one or more of the plurality of processing elements of the reconfigurable fabric;
manipulating the first tensor by the first agent;
storing results of the manipulating the first tensor in a storage element external from the first agent;
providing a pointer to a second agent deployed on one or more of the plurality of processing elements of the reconfigurable fabric, wherein the pointer identifies an address of the storage element at which the first tensor is stored; and
processing the first tensor by the second agent.

33. (canceled)

34. A tensor manipulation apparatus for processing a tensor on a reconfigurable fabric comprised of a plurality of processing elements, storage elements, and switching elements, the apparatus comprising:
means for deploying a first agent on one or more of a plurality of processing elements of the reconfigurable fabric;
means for manipulating the tensor by the first agent, and storing results of the manipulating the tensor in a storage element external from the first agent; and
means for providing a pointer to a second agent deployed on one or more of the plurality of processing elements of the reconfigurable fabric, wherein the pointer identifies an address of the storage element at which the tensor is stored.
